(19) United States
(12) Patent Application Publication
(10) Pub. No.: US 2024/0414543 A1
(43) Pub. Date: Dec. 12, 2024

(54) APPARATUS AND METHOD FOR AUTHENTICATING ADS-B TRACKS

(71) Applicant: BAE SYSTEMS Information and Electronic Systems Integration Inc., Nashua, NH (US)

(72) Inventors: Andrew E. Klappert, King Park, NY (US); David C. Ringlen, Coram, NY (US); Richard J. Lavery, Huntington, NY (US); Robert F. Saracino, Lindenhurst, NY (US)

(73) Assignee: BAE SYSTEMS Information and Electronic Systems Integration Inc., Nashua, NH (US)

(21) Appl. No.: 18/330,880

(22) Filed: Jun. 7, 2023

(51) Int. Cl. H04W 12/122; H04L 9/40

(52) U.S. Cl. CPC H04W 12/122; H04L 63/1483

(57) ABSTRACT

A method for discriminating between spoofed and valid ADS-B tracks includes applying a plurality of spoofing detection tests to an ADS-B waveform, applying weighting factors to the resulting test scores, and combining the weighted scores to obtain a confidence level indicating whether the ADS-B track is valid or spoofed. The detection tests can include power level validation, Doppler offset, ADS-B rules-based analysis, multi-band detection, track origination detection, and antenna diversity. The selection of applied detection tests and/or weighting factors can be adjusted and/or selected from corresponding libraries, according to operating conditions. Tracks can be displayed together with confidence level indications, and/or excluded from display if their confidence levels are below an adjustable threshold. Weighting factors can be chosen and/or updated by a machine learning model according to success in detecting simulated and/or actual spoofed tracks. A spoofing attack can be declared according to the number of spoofed tracks detected.

### RELATED APPLICATIONS

This application is related to U.S. patent application Ser. No. 18/206,905, filed Jun. 7, 2023 which is herein incorporated by reference in its entirety for all purposes.

### FIELD OF THE DISCLOSURE

The following disclosure relates generally to air traffic control, and, more specifically, to discrimination between valid and spoofed Automatic Dependent Surveillance-Broadcast (ADS-B) traffic/tracks.

### BACKGROUND

The number of aircraft using the National Airspace System (NAS), which includes airspace, navigation facilities, and airports of the United States, along with their associated information, services, rules, regulations, policies, procedures, personnel and equipment, as well as components shared jointly with the military, continues to increase. Accordingly, there is a need to increase the capacity of the NAS to handle the growing traffic. An approach that has been proposed, and partially implemented, is to distribute air traffic separation and management tasks among both airborne and ground-based systems. Examples of such approaches include “MODE-S” which provides identification and altitude information, as well as the “Automatic Dependent Surveillance-Broadcast” (ADS-B) standard. While the following disclosure refers primarily to the ADS-B, it will be understood that the disclosed system and method are equally applicable to position broadcasting technologies including ADS-B, MODE-S, AIS (Aircraft Identification System), and any combinations thereof, unless otherwise required by context.

ADS-B is an RF based identification system used worldwide by civilian aircraft for situational awareness (SA) and collision avoidance, and also to self-report position and other aircraft information. ADS-B relies on position information obtained by each ADS-B platform using GPS receivers, thereby replacing radar technology, which can be confused or blocked by intervening structures, weather phenomena, and other error sources, with information digitally transmitted by aircraft. Information about an aircraft's GPS location, altitude, ground speed and other data is broadcast by ADS-B systems to ground stations and other aircraft multiple times per second. Air traffic controllers and properly equipped aircraft can immediately receive this information. This offers more precise tracking of aircraft compared to radar technology, which sweeps for position information every 5 to 12 seconds. The ADS-B information is transmitted as a series of “squitters” each of which can include over 50 unique parameters.

The ADS-B waveform is unencrypted, and the FAA RTCA DO-260 specification that defines the ADS-B standard is publicly available, meaning that ADS-B transmissions can be readily received and transmitted using commercially available hardware. This approach has served to make ADS-B highly accessible to all types of aircraft, both civilian and military. Unfortunately, this approach has also rendered the ADS-B approach highly vulnerable to “spoofing,” wherein a “bad actor” can generate and transmit signals that appear to originate from an aircraft at a reported location, while in reality no such aircraft is present, at least not at the reported coordinates with the reported speed, heading, etc. Such bad actors can range from short-sighted hobbyists and pranksters to hostile nation states. In some cases, a single transmitter can be used to generate multiple inaccurate or erroneous ADS-B tracks, sometimes referred to herein as “spoofed tracks,” thereby increasing the impact of a spoofing attack.

The situation has been made even worse due to the proliferation of affordable and commercially available software defined transmitters, which has increased the risk of spoofing attacks on vulnerable, unencrypted waveforms like ADS-B. By creating spoofed tracks, bad actors can influence flight patterns of surrounding aircraft as they are forced to maneuver to avoid seemingly occupied airspace. Spoofed tracks can even be used to modify or conceal the actual locations and movements of hostile aircraft.

In addition to directly generating and transmitting false ADS-B waveforms, bad actors can also cause unsuspecting aircraft to issue inaccurate ADS-B transmissions by interfering with, spoofing, or jamming GPS signals, thereby causing the aircraft to issue inaccurate ADS-B information based on inaccurate GPS information obtained by the aircraft.

In general, there are at least three categories of ADS-B spoofing attacks: 1) reporting false ADS-B information to mask the true location of an ADS-B transponder; 2) intentionally generating spoofed ADS-B tracks in an effort to disrupt air traffic; and 3) jamming or spoofing GPS signals to cause an aircraft either not to transmit ADS-B information at all, or to transmit inaccurate ADS-B information.

What is needed therefore is an apparatus and method for detecting ADS-B spoofing attacks, and for discriminating between spoofed and valid ADS-B tracks.

### SUMMARY

The present disclosure is an apparatus and method for detecting ADS-B spoofing attacks, and for discriminating between spoofed and valid ADS-B tracks. Because there are many different types of spoofing attacks that can be deployed under different conditions by different bad actors having different resources available to them, the present disclosure recognizes that different spoofing detection tests may be optimal for detecting different types of attacks. Furthermore, it cannot be guaranteed that any one detection test will be immune to deception. For that reason, the present disclosure applies a plurality of detection tests to each received waveform in which an apparent ADS-B waveform or “track” is encoded. Weighting factors are applied to the results or “scores” that result from applying the detection tests, and then the weighted scores are combined to determine a “confidence level” that predicts whether the apparent ADS-B track is an accurate, valid track or a spoofed track. As is discussed in more detail below, these detection tests can include power level validation, ADS-B rules-based analysis, Doppler offset, multi-band detection, track origination detection, and antenna diversity, among others.

The disclosed system and method can be optimized to detect different types of attack under different conditions by selecting the detection tests to be implemented and the weighting factors to be applied. For example, different detection tests may be more or less effective, and may therefore be more or less heavily weighted, or even excluded, in a crowded rf environment, i.e. when many tracks are detected, as compared to a sparce environment where only a few tracks are detected. Similarly, detection tests may be weighted differently, or even excluded, depending on the time of day or night, and/or the visibility conditions. For example, different types of attack may be more likely under instrument flight rules (IFR) as compared to visible flight rules (VFR), causing different detection tests and/or weighting factors to be optimal. In embodiments, the order in which detection tests are applied, and/or the number of applied detection tests, can be varied as needed. For example, it may be desirable to implement fewer detection tests in a crowded RF environment, so as to update track information as rapidly as possible, while more detection tests may be implemented in sparce RF environments, especially under circumstances where highly sophisticated spoofing attacks are more likely.

Embodiments implement different approaches to adjust the display of tracks to personnel onboard the aircraft according to their confidence levels. For example, some embodiments display all received tracks to aircraft personnel, with numeric or symbolic annotations as to likelihood of spoofing. Color coding and/or indicia are used by some embodiments, such as tracks having high confidence levels being displayed in green, marginal tracks in yellow, and likely spoofed tracks in red. Numeric indications of the confidence levels can be associated with the displayed tracks. Another approach that is implemented in embodiments is to omit tracks that have confidence levels below a defined “cut-off” threshold, and are likely spoofed. The “cut-off” thresholds can be adjustable, either automatically and/or under user control. For example, marginal tracks and even low-confidence tracks may be displayed when only a few tracks are detected, but omitted when many tracks are detected, so as to avoid obfuscation of valid tracks by spoofed tracks. In embodiments, a user can adjust the “cut-off” to obtain an optimal balance of displayed information without obfuscation.

The result of applying each detection test is an estimate based on that detection test as to whether the track is valid or not, for example expressed as a percentage, where 100% indicates that no indication of spoofing was detected. The weighting factors can be determined based on the success of the detection test in detecting spoofed tracks resulting from simulated spoofing attacks, as well as spoofed tracks recorded during actual spoofing attacks. Anticipated degrees of success against different kinds of attacks can also be considered in terms of the strategy that is employed by the detection test and the natures of the hypothetical attack. Some of these considerations are described in more detail below.

A first general aspect of the present disclosure is an apparatus for discriminating between spoofed and valid ADS-B tracks. The apparatus includes an input configured to receive an ADS-B waveform detected by one or more antennae, an apparent ADS-B track being encoded in the ADS-B waveform, an ADS-B processing module configured to extract data from the ADS-B waveform, said data including digital data reported by the apparent ADS-B track, and a verifying unit configured to receive from the ADS-B processing module the extracted data from the ADS-B waveform, apply a plurality of detection tests to the extracted data, each of said detection tests resulting in a score indicating a degree of likelihood that the apparent ADS-B track is a valid ADS-B track, apply a weighting factor to each of the scores, and combine the scores to obtain a confidence level predicting whether the ADS-B waveform is a valid ADS-B waveform containing accurate ADS-B track information, or a spoofed waveform containing inaccurate or specious ADS-B track information.

In embodiments, the plurality of detection tests includes at least one of an ADS-B rules-based analysis applied to the digital data reported by the ADS-B track a multi-band detection analysis applied to the digital data reported by the ADS-B track and a track origination detection analysis applied to the digital data reported by the ADS-B track.

In any of the above embodiments, the data extracted from the ADS-B waveform can further include a detected power level at which the ADS-B waveform was detected, and the plurality of detection tests can include a power level validation applied to the detected power.

In any of the above embodiments, the one or more antennae can include at least two antennae, the data extracted from the ADS-B waveform can further include detection power levels at which the ADS-B waveform was detected by each of the at least two antennae, and the plurality of detection tests can include an antenna diversity analysis applied to the detection power levels.

In any of the above embodiments, the data extracted from the ADS-B waveform can further include a Doppler offset, and the plurality of detection tests can include comparing the Doppler offset with velocities, headings, and/or changes thereof that are reported by the apparent ADS-B track.

In any of the above embodiments, the verifying unit can further include a weighting factor library containing a plurality of sets of weighting factors, and applying a weighting factor to each of the scores can include selecting one of the sets of weighting factors from the weighting factor library, and applying the weighting factors of the selected set to the scores.

In any of the above embodiments, the verifying unit can further include a detection test library containing a plurality of detection tests, and applying the plurality of detection tests to the extracted data can include selecting a plurality of detection tests from the detection test library, and applying the selected detection tests to the extracted data.

In any of the above embodiments, the verifying unit can be further configured to generate display data according to apparent ADS-B tracks encoded in a plurality of detected ADS-B waveforms and their associated confidence levels, and to forward the display data to a “situational awareness” display (SA). In some of these embodiments generating the display data includes associating annotations with the apparent ADS-B tracks, said annotations being indicative of the confidence levels associated with the apparent ADS-B tracks. And in any of these embodiments generating the display data can include excluding from the display data apparent ADS-B tracks having confidence levels associated therewith that are below a specified minimum confidence level.

A second general aspect of the present disclosure is a method of discriminating between spoofed and valid ADS-B tracks. The method includes receiving an ADS-B waveform, an apparent ADS-B track being encoded in the ADS-B waveform, extracting data from the ADS-B waveform, said data including digital data reported by the apparent ADS-B track, applying a plurality of detection tests to the data extracted from the ADS-B waveform, each of said detection test applications resulting in a corresponding score indicating a degree of likelihood that the apparent ADS-B track is a valid ADS-B track, applying a weighting factor to each of the scores, and combining the weighted scores to obtain a confidence level predicting whether the ADS-B waveform is a valid ADS-B waveform containing accurate ADS-B track information, or a spoofed waveform containing inaccurate or specious ADS-B track information.

In embodiments, applying the plurality of detection tests includes applying to the digital data reported by the ADS-B track at least one of an ADS-B rules-based analysis, a multi-band detection analysis, and a track origination detection analysis.

In any of the above embodiments, extracting data from the ADS-B waveform can include determining a detection power at which the ADS-B waveform was detected, and applying the plurality of detection tests can include applying a power level analysis to the detection power.

In any of the above embodiments, extracting the data from the ADS-B waveform can include determining detection power levels at which the ADS-B waveform was detected by at least two antennae, and applying the plurality of detection tests can include applying an antenna diversity analysis to the detection power levels.

In any of the above embodiments, extracting the data from the ADS-B waveform can include determining a Doppler offset, and applying the plurality of detection tests can include comparing the Doppler offset with velocities, headings, and/or changes thereof that are reported by the apparent ADS-B track. In some of these embodiments, determining the Doppler offset includes estimating the Doppler offset from baseband waveform samples over a duration of a pulse train.

In any of the above embodiments, applying a weighting factor to each of the validity scores can include selecting a set of weighting factors from a weighting factor library, and applying the weighting factors of the selected set to the scores.

In any of the above embodiments, applying the plurality of detection tests to the extracted data can include selecting a plurality of detection tests from a detection test library, and applying the selected detection tests to the data extracted from the ADS-B waveform.

Any of the above embodiments can further include generating display data according to apparent ADS-B tracks encoded in a plurality of detected ADS-B waveforms and their associated confidence levels, and forwarding the display data to a “situational awareness” display (SA). In some of these embodiments, generating the display data includes associating annotations with the apparent ADS-B tracks, said annotations being indicative of the confidence levels associated with the ADS-B tracks. And any of these embodiments can include excluding from the display data apparent ADS-B tracks having confidence levels associated therewith that are below a specified minimum confidence level.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the inventive subject matter.

### BRIEF DESCRIPTION OF THE DRAWINGS

These and other features of the present embodiments will be understood better by reading the following detailed description, taken together with the figures herein described. For purposes of clarity, not every component may be labeled in every drawing.

FIG. 1A is a simplified illustration of the primary components included in a system embodiment of the present disclosure;

FIG. 1B is a flow diagram illustrating elements of an ADS-B validating system and situational awareness display and interactions therebetween according to an embodiment of the present disclosure;

FIG. 2 is a table that presents an exemplary set of detection tests and associated weights and scores according to an embodiment of the present disclosure;

FIG. 3 is a flow diagram that illustrates selection and updating of weighting factors according to a machine learning model in an embodiment of the present disclosure;

FIG. 4 is a flow diagram that is similar to FIG. 1B, but wherein data extracted from a received ADS-B waveform includes RF data, Mode-S data, and ADS-B data, according to an embodiment of the present disclosure;

FIG. 5A is a table that presents an exemplary set of results of applying an ADS-B data validation detection test to an ADS-B track according to an embodiment of the present disclosure, wherein the detection test results in a high detection test score;

FIG. 5B is a table similar to FIG. 5A, but wherein the detection test results in a low detection test score; and

FIG. 6 is a flow diagram illustrating a method embodiment of the present disclosure.

### DETAILED DESCRIPTION

The present disclosure is an apparatus and method for detecting ADS-B spoofing attacks, and for discriminating between spoofed and valid ADS-B tracks. Because there are many different types of spoofing attacks that can be deployed under different conditions by different bad actors having different resources available to them, the present disclosure recognizes that different spoofing detection tests, referred to herein as “detection tests,” may be optimal for detecting different types of attacks. Furthermore, it cannot be guaranteed that any one detection test will be immune to deception.

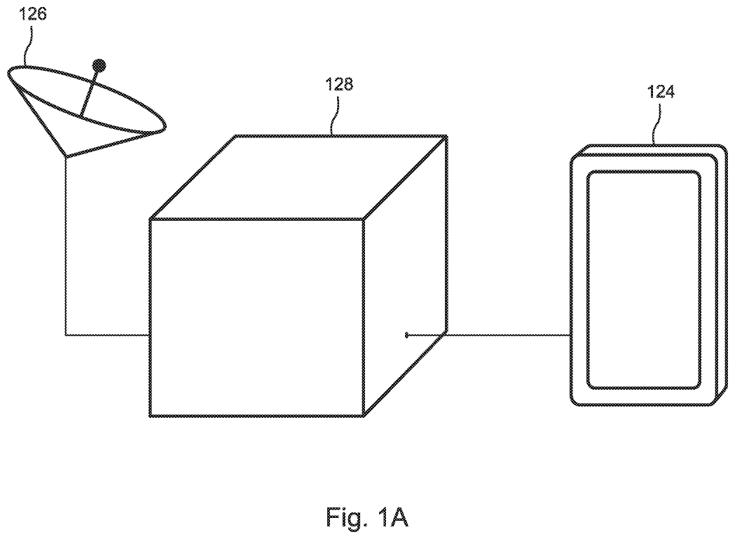

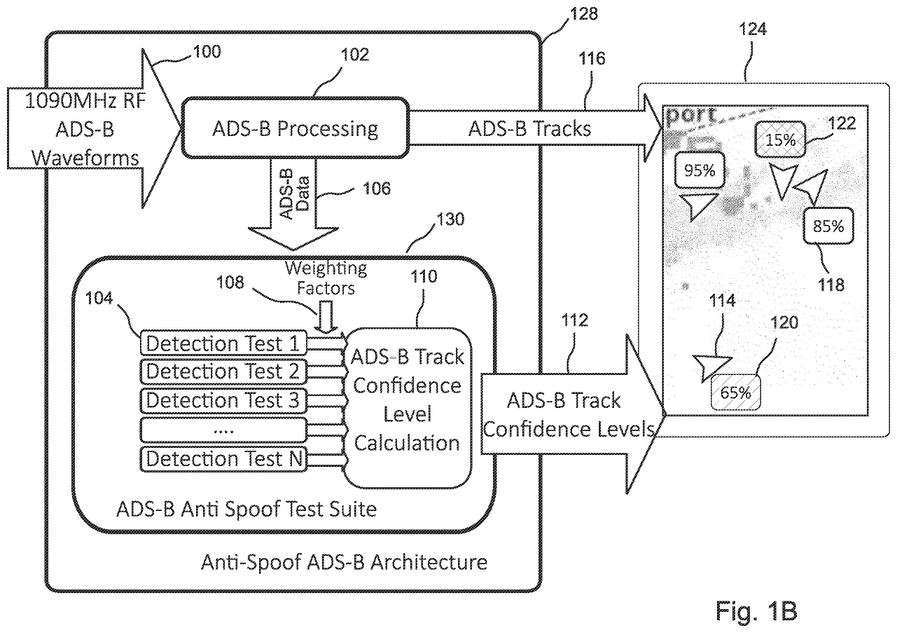

With reference to FIG. 1A, the present disclosure includes an antenna 126 configured to receive ADS-B track waveforms, an ADS-B receiver 128 configured to receive and analyze the ADS-B waveforms, and a “situational awareness” display (SA) 124 configured to display information provided to it by the ADS-B receiver. Alternatively, the apparatus can issue alerts to an operator or undertake an automated response based on the results. For example, identifying the spoofed signal and sending for identification or jamming.

With reference to FIG. 1B, after receiving an ADS-B track waveform 100 from the antenna 126, an ADS-B processing module 102 within the ADS-B receiver 128 extracts analysis data 106 from the track 100 and forwards the analysis data 106 to a verifying unit 130 that is configured to determine a confidence level 112 as to whether or not the ADS-B track 100 is valid, or whether it is spoofed. A plurality of software/firmware detection tests 104 associated with one or more processors are applied by the verifying unit 130 to the analysis data 106. The result of applying the detection tests 104 is an initial confidence level as to whether the track 100 is valid or not, for example expressed as a percentage, where 100% indicates that no indication of spoofing was detected. Weighting factors 108 are applied to the results of the detection tests 104. Finally, the weighted results are summed or otherwise combined to determine an overall “confidence level” 110 that predicts whether the received signal is an accurate, valid track or a spoofed track.

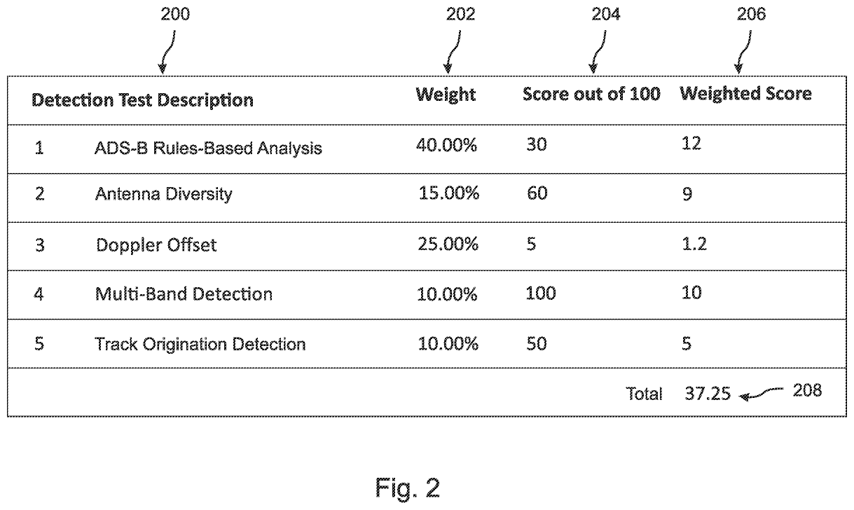

FIG. 2 presents an example from an embodiment wherein five detection tests 200 are applied having weighting factors 202 ranging from 10% to 40% (and totaling 100%). The weighting factors 202 are applied to the results or “scores” 204 provided by the detection tests 200 to produce weighted scores 206, which are then totaled to obtain the confidence level 208. The weighting factors are based upon a priori information and can be updated as further data is processed.

In various embodiments, the disclosed system and method can be optimized to detect different types of attack under different conditions by selecting the detection tests to be implemented and the weighting factors to be applied. For example, different detection tests may be more or less effective, and may therefore be more or less heavily weighted, or even excluded, in a crowded RF environment, i.e. when many tracks are detected, as compared to a sparce environment where only a few tracks are detected. Similarly, detection tests may be weighted differently, or even excluded, depending on the time of day or night, and/or the visibility conditions. As another example, different types of attack may be more likely under instrument flight rules (IFR) as compared to visible flight rules (VFR), causing different detection tests and/or weighting factors to be optimal. In embodiments, the order in which detection tests are applied, and/or the number of applied detection tests, can be varied as needed. As yet another example, it may be desirable to implement fewer detection tests in a crowded RF environment so as to update track information as rapidly as possible, while more detection tests may be implemented in sparce RF environments, especially under circumstances where highly sophisticated spoofing attacks are more likely. In embodiments, a plurality of pre-determined sets of weighting factors are provided in a library, and selected in real time according to current operating conditions of the aircraft.

The weighting factors can be determined based on the success of the detection test in detecting spoofed tracks resulting from simulated spoofing attacks, as well as spoofed tracks recorded during actual spoofing attacks. Anticipated degrees of success against different kinds of attacks can also be considered in terms of the strategy that is employed by the detection test and the natures of the hypothetical attack.

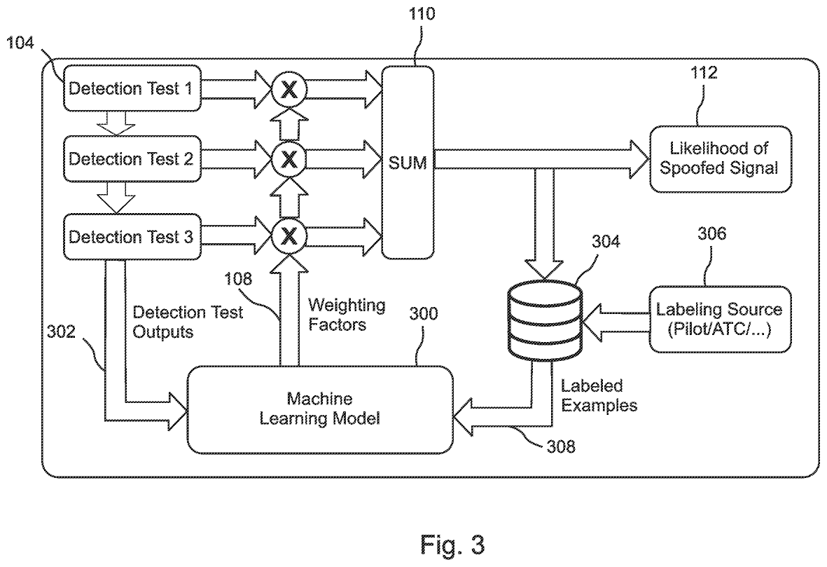

With reference to FIG. 3, the weighting factors 108 can be chosen and updated by a machine learning model (ML) 300, which can be trained using simulated and previously recorded actual spoofed tracks. In embodiments, the ML can be further trained in real time, while the anti-spoofing apparatus and method are deployed. According to this approach, as tracks are detected 100, the estimates 302 or “scores” produced by the detection tests 104 are provided to the ML 300. In addition, the tracks 304 are presented to the ML for further training as “labeled examples” 308, having been labeled as either valid or spoofed by a labeling source 306, such as the pilot of the aircraft, a radar system, or air traffic control. For example, if a track 304 appears on the (SA) 124 as supposedly being at a location that is within the pilot's field of view, but the pilot looks out of the windshield and does not see the expected aircraft, then the pilot can label the track 304 as a spoofed track. Thus the user can improve the performance by providing dynamic feedback. In embodiments, if it is not convenient for the pilot to provide this information to the ML 300 in real time, it can be provided later as further training data for the ML 300.

With reference again to FIG. 1B, embodiments implement different approaches to display the confidence levels of the tracks to personnel onboard the aircraft. For example, in the illustrated embodiment, all of the detected tracks 116 appear as icons 114 on the SA 124 indicating their apparent locations and directions of flight. The confidence levels 110 are also forwarded 112 to the SA 124, where they are displayed as indicia containing numeric indications 118-122 that are associated with each track icon 114. According to pre-determined thresholds, the confidence level indicia 118-122 in the illustrated embodiment include background colors of green 118, yellow 120, or red 122, depending on whether the confidence level is high (track is likely valid), marginal (track is suspicious), or low (track is likely spoofed).

Other embodiments are configured to omit tracks from the SA 124 that have confidence levels 110 below a defined “cut-off” threshold, especially when a large number of ADS-B tracks 100 are detected. These “cut-off” thresholds can be adjustable, either automatically or under user control. For example, marginal tracks and even low-confidence tracks may be displayed when only a few tracks are detected, as shown in FIG. 1B, but omitted when many tracks are detected, so as to avoid obfuscation of valid tracks by spoofed tracks. In embodiments, a user can adjust the “cut-off” to obtain an optimal balance of displayed information without obfuscation.

In embodiments, once the confidence levels have been determined for the individual tracks that are currently being received, they can be averaged or otherwise combined to provide an overall “environment” confidence level, which can indicate whether or not spoofing activity is occurring, so that the pilot or other personnel onboard the aircraft can take appropriate precautions.

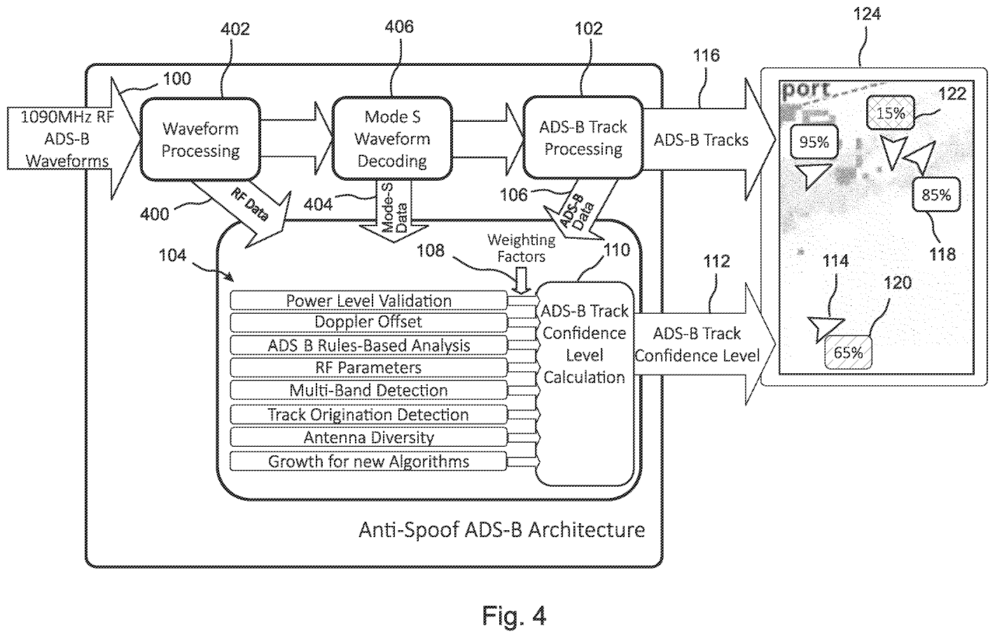

With reference to FIG. 4, in embodiments the detection tests 104 are applied not only to the digital ADS-B data 106 that is derived from by the ADS-B processing module 102 from the received signals, but also to analog RF data 400 derived from waveform analysis 402 of the received signals and reported Mode-S and/or data AIS data 404 (identification and altitude) derived from Mode-S decoding 406 of the received signals. This added information enables a much wider range of detection tests 104 to be applied.

Following are descriptions of some of the detection tests that are employed in embodiments of the present disclosure. These descriptions represent definitions of the names or labels used herein for these detection tests, including “power level validation,” “ADS-B rules-based analysis,” “multi-band detection,” “Doppler Offset,” “track origination detection,” and “antenna diversity.”

### Power Level Validation

In embodiments, the RF data 400 includes the detected power of the received signal. This can be used to detect spoofing in at least two ways. First, by comparing the detected power level with the identity (type of aircraft) and location that are reported in the ADS-B data. If the detected power level is not consistent with the reported ADS-B data, e.g. too weak or too strong, then the detection test reports a lower validity estimate. Second, the power level of the received signal can be tracked over time, and compared with changes in the ADS-B reported position of the track. If the detected power level does not fluctuate over time as would be expected based on the supposed changes in range to the track, then the detection test reports a lower validity estimate.

Tracking the detected power level over time is expected to be sensitive to spoofing by both unsophisticated and sophisticated attacks, especially if spoofing detection data is shared between aircraft, because even if a spoofer is sophisticated enough to vary its transmit power in an attempt to simulate changes in range, it would not be possible to provide convincing simulations to receivers at multiple locations simultaneously. For example, a stationary spoofer would not be able to simulate an approach to a first receiver by increasing its transmit power, while at the same time appearing to be traveling away from a second receiver that would expect the received power to be decreasing.

### ADS-B Rules-Based Analysis

The ADS-B standard is complex, with a large number of rules that define which data is populated into which fields. Specific combinations of data must be provided under specific conditions, and the timing for transmitting the information is very specific. Valid ADS-B transponders that transmit authentic ADS-B messages go through a rigorous certification process, and can be expected to transmit authentic messages that meet all of the ADS-B transmission rules. It is likely that less sophisticated spoofing attacks arising, for example, from short-sighted hobbyists and pranksters, as well as poorly funded terrorists, may transmit spoofed ADS-B tracks that do not comply with all of these ADS-B requirements, such that a comprehensive verification of the adherence of a received track to ADS-B rules can be a useful tool for detecting spoofed tracks.

In particular, if it is found that a track does not satisfy all of the ADS-B requirements, this would be a strong indication of spoofing, while passing by a track of the rules-based analysis may be a less definite indication of validity. It is noted that this detection test may not be effective against spoofing attacks that disrupt or spoof GPS signals, because the tracks, while erroneous, would be transmitted by valid, certified ADS-B transponders, and would therefore likely adhere to all of the rules required by the ADS-B standard. It is notable that this detection test does not depend on any analysis of the analog properties of the received ADS-B waveform.

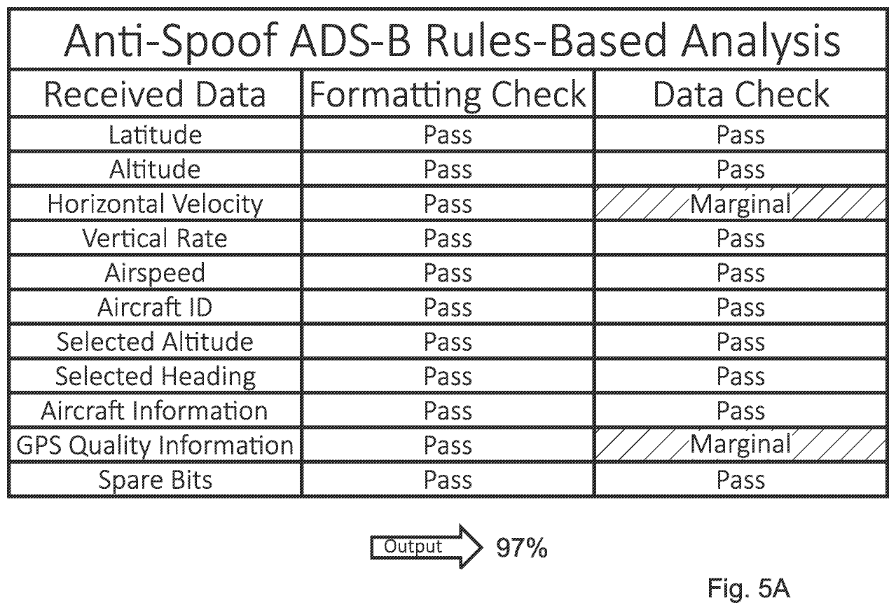

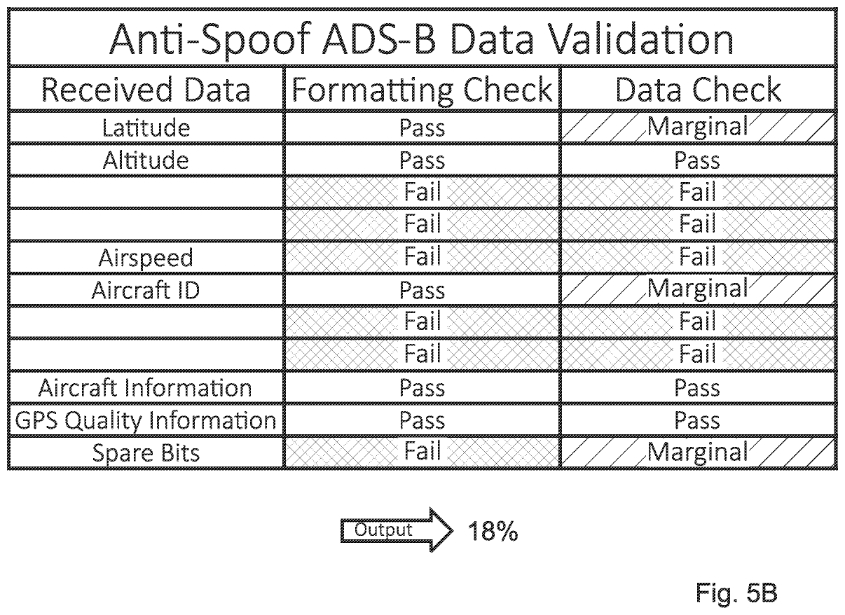

Some of the ADS-B rule checks that are performed in embodiments as part of a rules-based detection test are illustrated in FIGS. 5A and 5B. These can include formatting checks, which verify if the data is formatted in accordance with data definitions in the ADS-B Specification, as well as data checks that verify whether the reported data is within acceptable ranges and are self-consistent, such as latitude being within the limits of −90° to +90° and incrementing proportionately to the reported velocity of the track. In FIG. 5A, the received track satisfies all of the formatting checks, and all but two of the data checks, with those two being “marginal.” The result is an estimate of 97% that the track is valid. In contrast, the received track of FIG. 5B fails 7 of the formatting checks and 5 of the data checks, with three more of the data checks being “marginal.” As a result, the estimate of validity is only 18%.

### Multi-Band Detection

So as to avoid bandwidth saturation when a large number of ADS-B tracks are present, the ADS-B standard provides 2 channels at different frequencies. Because aircraft will not necessarily be able to monitor both of these channels, the Federal Aviation Administration (FAA) selectively rebroadcasts tracks from 1 channel onto the other to ensure aircraft have a complete picture of surrounding aircraft. The rebroadcast of traffic across these 2 channels is called ADS-R and TIS-B, for differing types of data. One possible spoofing approach would be for an adversary to transmit its spoofed tracks as apparently having been rebroadcast by the FAA. Embodiments of the apparatus of the present disclosure include a dual band receiver that can monitor both ADS-B channels simultaneously, so that apparently rebroadcast ADS-B tracks can be confirmed as authentic. Once a transmitter of ADS-R and TIS-B messages is determined not to be authentic, other detection tests as described herein can be deployed to invalidate all transmissions from the spoofer. This detection test is directed specifically at spoofing attacks that simulate rebroadcasted ADS-B waveforms.

### Doppler Offset

Doppler offset is also used, in embodiments, to verify the validity of an ADS-B track. This offset can be estimated from the baseband waveform samples over the duration of a pulse train. For instance, if a valid track is moving away from or towards a receiver, its Doppler offset can be noted, and should not change significantly unless an analogous change to the relative velocity is reported by the track. If a track reports position and velocity changes relative to the receiver, but the expected doppler changes are not observed, then it is likely a spoofed track. This detection test is likely to detect spoofed tracks generated by sources that are stationary, or otherwise are not executing movements that correspond to velocities and headings that are reported in the spoofed track.

### Track Origination Detection

Valid ADS-B tracks will typically enter the detection range of a receiver in either of two ways, either as they transition from beyond detection range into detection range, or as they take off and transition from the ground to the air. According to this detection test, if a new track is detected at an improbable location, for example already airborne and well within detection range, or as apparently still being beyond detection range, then the track will be deemed to likely be a spoofed track. Indeed, if a track ever reports its position as being a location that is beyond detection range, then it will be deemed to likely be a spoofed track. This detection test is expected to be effective against virtually any type of spoofing attack, but only under specific circumstances.

### Antenna Diversity

ADS-B receivers include two or more omnidirectional antennae, one of which is on the top side of the aircraft and the other on the bottom side, in accordance with the specification referred to as RTCA DO-260B. Receivers are able to determine which of these antennae (upper/lower) is receiving a signal with higher power, so that the antenna with the higher power can be used for demodulation and decoding of ADS-B waveforms. This process is part of the Diversity functionality, as defined in RTCA DO-260B. The receiver channels also determine absolute power of the received signals.

Embodiments make use of this dual antenna power comparison to determine whether a received signal originates from an altitude above the receiver or below the receiver. If this determination does not agree with the altitude that is reported in the ADS-B track, then the track will be deemed to likely be spoofed. For example, if the track reports its position as being at an altitude that is above the receiver, while the signal actually originates from the ground, then it is almost certainly spoofed. This detection test is also expected to be effective against virtually any type of spoofing attack, but only under specific circumstances.

The foregoing description of the embodiments of the disclosure has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the disclosure to the precise form disclosed. Many modifications and variations are possible in light of this disclosure.

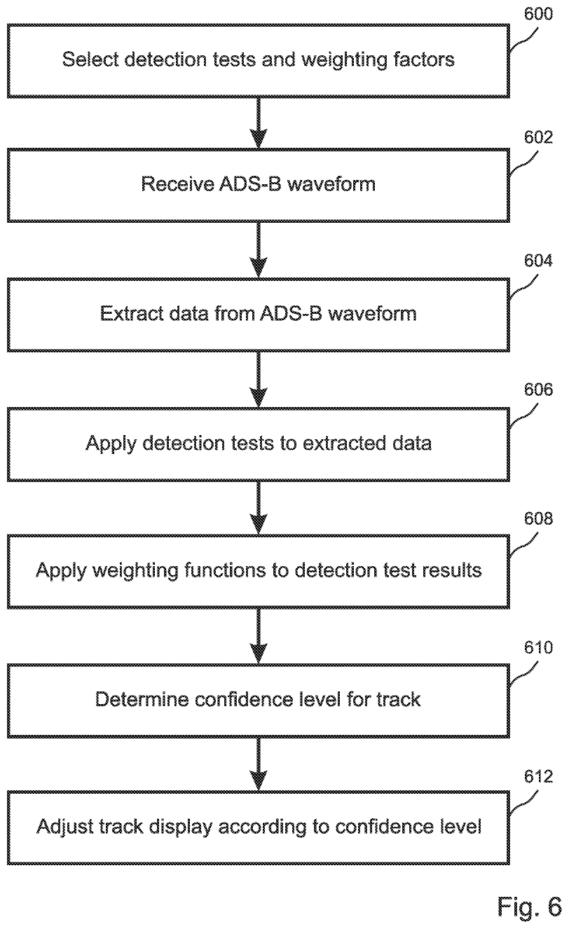

With reference to FIG. 6, the method of the present disclosure includes selecting a plurality of spoofing detection tests and associated weighting factors 600 that will be applied to a detected ADS-B waveform by the one or more processors in the ADS-B receiver 128. In one example there are a multitude of detection tests available to the processors, and a subset including those that are most relevant to the particular ADS-B waveform are utilized. The detection tests can be changed dynamically depending upon the results, and “better” detection tests can be selected, i.e. detection test can be added to and dropped from the applied subset as needed. The two or more antennae are used for receiving an ADS-B waveform 602, processing the signal to extract ADS-B data, and in embodiments also waveform RF data and AIS/Mode-S identification data 604. The processing according to the detection tests is used to obtain the extracted data or results 606 for an initial confidence level of the tracks. The processing continues by applying the associated weighting factors 608 to the initial confidence levels, and then combining the weighted results to obtain a final confidence level for the tracks 610. In one example, a display adjusts the presentation of tracks according to the confidence levels 612. In various embodiments, adjusting the presentation of tracks can include applying colors and/or indicia to the tracks to indicate the confidence levels, displaying numeric confidence levels in association with the tracks, and/or omitting tracks with low confidence levels from display that have confidence levels below a cut-off threshold.

Although the present application is shown in a limited number of forms, the scope of the disclosure is not limited to just these forms, but is amenable to various changes and modifications. The disclosure presented herein does not explicitly disclose all possible combinations of features that fall within the scope of the disclosure. The features disclosed herein for the various embodiments can generally be interchanged and combined into any combinations that are not self-contradictory without departing from the scope of the disclosure. In particular, the limitations presented in dependent claims below can be combined with their corresponding independent claims in any number and in any order without departing from the scope of this disclosure, unless the dependent claims are logically incompatible with each other.

What is claimed is:

1. An apparatus for discriminating between spoofed and valid ADS-B tracks, the apparatus comprising:
an input configured to receive an ADS-B waveform detected by one or more antennae, an apparent ADS-B track being encoded in the ADS-B waveform;
an ADS-B processing module configured to extract data from the ADS-B waveform, said data including digital data reported by the apparent ADS-B track; and
a verifying unit configured to:
receive from the ADS-B processing module the extracted data from the ADS-B waveform;
apply a plurality of detection tests to the extracted data, each of said detection tests resulting in a score indicating a degree of likelihood that the apparent ADS-B track is a valid ADS-B track;
apply a weighting factor to each of the scores; and
combine the scores to obtain a confidence level predicting whether the ADS-B waveform is a valid ADS-B waveform containing accurate ADS-B track information, or a spoofed waveform containing inaccurate or specious ADS-B track information.

2. The apparatus of claim 1, wherein the plurality of detection tests includes at least one of:
an ADS-B rules-based analysis applied to the digital data reported by the ADS-B track;
a multi-band detection analysis applied to the digital data reported by the ADS-B track; and
a track origination detection analysis applied to the digital data reported by the ADS-B track.

3. The apparatus of claim 1, wherein the data extracted from the ADS-B waveform further includes a detected power level at which the ADS-B waveform was detected, and wherein the plurality of detection tests includes a power level validation applied to the detected power.

4. The apparatus of claim 1, wherein:
the one or more antennae includes at least two antennae;
the data extracted from the ADS-B waveform further includes detection power levels at which the ADS-B waveform was detected by each of the at least two antennae; and
the plurality of detection tests includes an antenna diversity analysis applied to the detection power levels.

5. The apparatus of claim 1, wherein the data extracted from the ADS-B waveform further includes a Doppler offset, and wherein the plurality of detection tests includes comparing the Doppler offset with velocities, headings, and/or changes thereof that are reported by the apparent ADS-B track.

6. The apparatus of claim 1, wherein the verifying unit further includes a weighting factor library containing a plurality of sets of weighting factors, and wherein applying a weighting factor to each of the scores includes selecting one of the sets of weighting factors from the weighting factor library, and applying the weighting factors of the selected set to the scores.

7. The apparatus of claim 1, wherein the verifying unit further includes a detection test library containing a plurality of detection tests, and wherein applying the plurality of detection tests to the extracted data includes selecting a plurality of detection tests from the detection test library, and applying the selected detection tests to the extracted data.

8. The apparatus of claim 1, wherein the verifying unit is further configured to generate display data according to apparent ADS-B tracks encoded in a plurality of detected ADS-B waveforms and their associated confidence levels, and to forward the display data to a “situational awareness” display (SA).

9. The apparatus of claim 8, wherein generating the display data includes associating annotations with the apparent ADS-B tracks, said annotations being indicative of the confidence levels associated with the apparent ADS-B tracks.

10. The apparatus of claim 8, wherein generating the display data includes excluding from the display data apparent ADS-B tracks having confidence levels associated therewith that are below a specified minimum confidence level.

11. A method of discriminating between spoofed and valid ADS-B tracks, the method comprising:
receiving an ADS-B waveform, an apparent ADS-B track being encoded in the ADS-B waveform;
extracting data from the ADS-B waveform, said data including digital data reported by the apparent ADS-B track;
applying a plurality of detection tests to the data extracted from the ADS-B waveform, each of said detection test applications resulting in a corresponding score indicating a degree of likelihood that the apparent ADS-B track is a valid ADS-B track;
applying a weighting factor to each of the scores; and
combining the weighted scores to obtain a confidence level predicting whether the ADS-B waveform is a valid ADS-B waveform containing accurate ADS-B track information, or a spoofed waveform containing inaccurate or specious ADS-B track information.

12. The method of claim 11, wherein applying the plurality of detection tests includes applying to the digital data reported by the ADS-B track at least one of:
an ADS-B rules-based analysis;
a multi-band detection analysis; and
a track origination detection analysis.

13. The method of claim 11, wherein extracting data from the ADS-B waveform includes determining a detection power at which the ADS-B waveform was detected, and wherein applying the plurality of detection tests includes applying a power level analysis to the detection power.

14. The method of claim 11, wherein extracting the data from the ADS-B waveform includes determining detection power levels at which the ADS-B waveform was detected by at least two antennae, and wherein applying the plurality of detection tests includes applying an antenna diversity analysis to the detection power levels.

15. The method of claim 11, wherein extracting the data from the ADS-B waveform includes determining a Doppler offset, and wherein applying the plurality of detection tests includes comparing the Doppler offset with velocities, headings, and/or changes thereof that are reported by the apparent ADS-B track.

16 The method of claim 15, wherein determining the Doppler offset includes estimating the Doppler offset from baseband waveform samples over a duration of a pulse train.

17 The method of claim 11, wherein applying a weighting factor to each of the validity scores includes selecting a set of weighting factors from a weighting factor library, and applying the weighting factors of the selected set to the scores.

18. The method of claim 11, wherein applying the plurality of detection tests to the extracted data includes selecting a plurality of detection tests from a detection test library, and applying the selected detection tests to the data extracted from the ADS-B waveform.

19. The method of claim 11, further comprising generating display data according to apparent ADS-B tracks encoded in a plurality of detected ADS-B waveforms and their associated confidence levels, and forwarding the display data to a “situational awareness” display (SA).

20. The method of claim 19, wherein generating the display data includes associating annotations with the apparent ADS-B tracks, said annotations being indicative of the confidence levels associated with the ADS-B tracks.

21. The method of claim 19, wherein generating the display data includes excluding from the display data apparent ADS-B tracks having confidence levels associated therewith that are below a specified minimum confidence level.
